(19) United States
(12) Patent Application Publication
(10) Pub. No.: US 2026/0280734 A1
(43) Pub. Date: Sep. 17, 2026

(54) METHODS, COMMUNICATIONS DEVICES AND INFRASTRUCTURE EQUIPMENT

(71) Applicant: Sony Group Corporation, Tokyo (JP)

(72) Inventors: Shin Horng WONG, Basingstoke (GB); Naoki KUSASHIMA, Basingstoke (GB); Yassin Aden AWAD, Basingstoke (GB)

(73) Assignee: Sony Group Corporation, Tokyo (JP)

(21) Appl. No.: 19/168,343

(22) PCT Filed: Mar. 28, 2024
(86) PCT No.: PCT/EP2024/058700

§ 371 Date: Sep. 24, 2025

(30) Foreign Application Priority Data
Apr. 6, 2023 (EP) 23167159.5

(51) Int. Cl. H04B 17/318; H04B 7/06

(52) U.S. Cl. CPC H04B 17/328; H04B 7/0695

(57) ABSTRACT

A method of operating a communications device configured to communicate with infrastructure equipment of a wireless communications network via a wireless access interface. The method includes receiving, through the wireless access interface, one or more synchronisation signal block (SSB) burst sets, each burst set comprising one or more SSBs received on one or more respective beams. The wireless access interface comprises a plurality of slots including a plurality of orthogonal frequency division multiplexing (OFDM) symbols for carrying the SSBs in the burst set, wherein one or more of the OFDM symbols are SBFD OFDM symbols and one or more are non-SBFD OFDM symbols. The method further comprises determining a signal quality for each beam based on a measurement of one or more SSBs received on the beam, including adjusting the signal quality measurement according to whether the SSBs are received in the SBFD OFDM symbols or the non-SBFD OFDM symbols.

### BACKGROUND

### Field of Disclosure

The present disclosure relates to communications devices, infrastructure equipment, and methods of operating communications devices and infrastructure equipment in a wireless communications network. The present disclosure claims the Paris convention priority to European patent application number EP23167159.5 filed on 6 Apr. 2023, the contents of which are incorporated herein by reference in its entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method operating a communications device. The method comprises receiving, from infrastructure equipment of a wireless communications network via a wireless access interface, one or more synchronisation signal block, SSB, burst sets. Each burst set comprises one or more SSBs. The one or more SSBs in each burst set are received on a respective one or more beams. The wireless access interface comprises a plurality of slots. Each of the plurality of slots comprises a plurality of Orthogonal Frequency Division Multiplexing, OFDM, symbols for receiving the one or more of SSBs in each burst set. One or more of the OFDM symbols are SBFD OFDM symbols and one or more of the OFDM symbols are non-SBFD OFDM symbols. The method comprises determining a signal quality for each beam based on a signal quality measurement of one or more of the SSBs received on the beam including adjusting the measurement of the signal quality of one or more of the SSBs received on the beam according to whether they are received in the plurality of SBFD OFDM symbols or the plurality of non-SBFD OFDM symbols.

By adjusting the measurement of the signal quality of one or more SSBs received on the beam according to whether they are received in the one or more SBFD OFDM symbols or the one or more non-SBFD OFDM symbols, the effects of interference on SSB signal quality measurements can be reduced or removed, thereby providing an improvement in SSB signal quality measurement consistency and accuracy.

Embodiments of the present technique can also provide methods of operating infrastructure equipment, communications devices, infrastructure equipment, circuitry for communications devices, circuitry for infrastructure equipment computer programs, and computer-readable storage mediums.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically represents an example of non-overlapping subbands for uplink and downlink transmissions;

FIG. 5 schematically represents an example of non-overlapping subbands for uplink and downlink transmissions;

FIG. 6 schematically illustrates an example of intra-cell cross link interference;

FIG. 7 schematically illustrates an example of inter sub-band interference;

FIG. 8 schematically illustrates the components of an SSB;

FIG. 9 schematically illustrates an SSB burst set transmitted on SSB beams;

FIG. 10 schematically illustrates SSB in SBFD and non-SBFD OFDM symbols;

FIG. 11 schematically illustrates a method of operating a communications device in accordance with example embodiments;

FIG. 12 schematically illustrates separate measurements for the same SSB in SBFD OFDM symbols and in non-SBFD symbols in accordance with example embodiments;

FIG. 13 schematically illustrates an SSB overlapping with SBFD OFDM symbols in accordance with example embodiments;

FIG. 14 schematically illustrates different levels of SBFD symbol overlap in accordance with example embodiments;

FIG. 15 schematically illustrates selecting resource elements of an SSB for measurement in accordance with example embodiments.

### DETAILED DESCRIPTION OF THE EMBODIMENTS

### Long Term Evolution Advanced Radio Access Technology (4G)

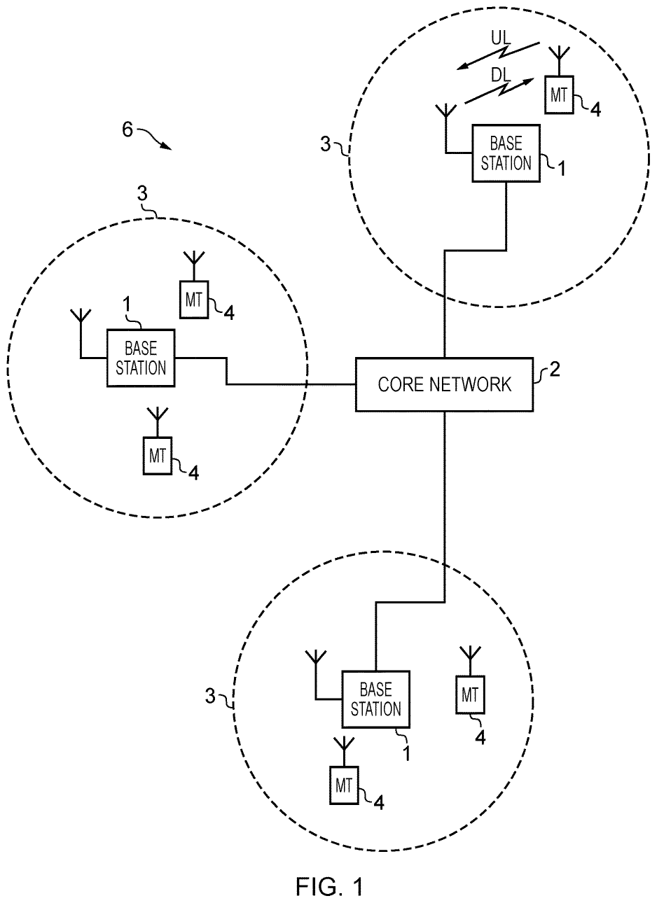

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

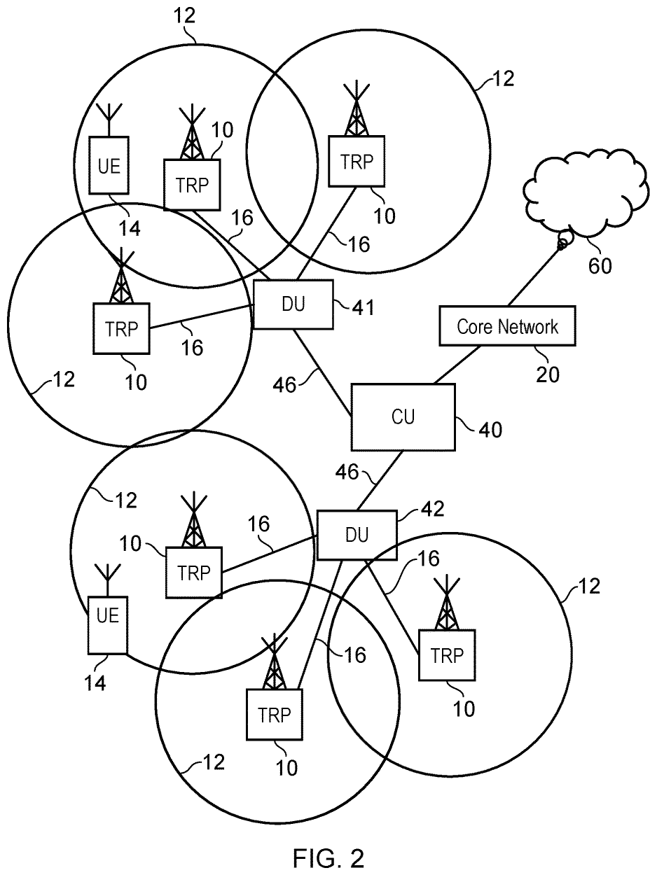

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 60.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

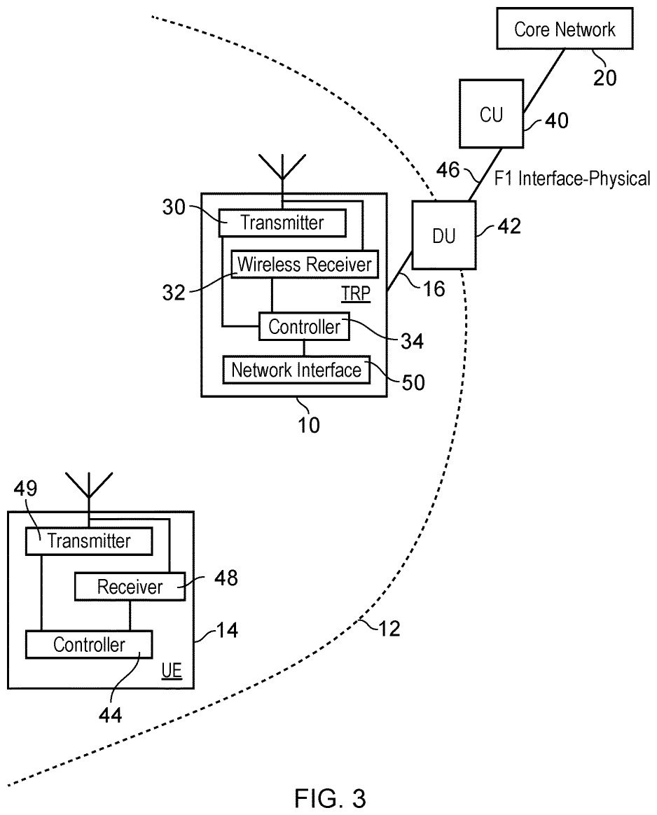

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band or carrier is switched to either downlink or uplink transmissions for a time period and can be switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for Time Division Duplex (TDD) by enabling Full Duplex operation in TDD (FD-TDD) [3], [4].

In FD-TDD, a gNB can transmit and receive data to and from the UEs at the same time on the same frequency band. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling a UL transmission from a second UE within the same orthogonal frequency division multiplexing (OFDM) symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD. Development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, OFDM symbols are allocated only for either a DL or UL direction in a semi-static manner. Hence, if one direction experiences less or no data, the spare resources cannot be used in the other direction, or are, at best, under-utilized. However, if resources can be used for DL data and UL data (as in FD-TDD) at the same time, the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually coverage limited in their UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would allow a UE to be assigned more UL time resources when required, without sacrificing DL time resources.

### Subband Full Duplex (SBFD)

In SBFD, the frequency resource of a TDD system bandwidth or Bandwidth Part (BWP) (i.e. at the UE/gNB) is divided into two or more non-overlapping sub-bands, where each sub-band can be DL or UL [5]. Guard subbands may be used between DL and UL subbands to reduce inter subband interference.

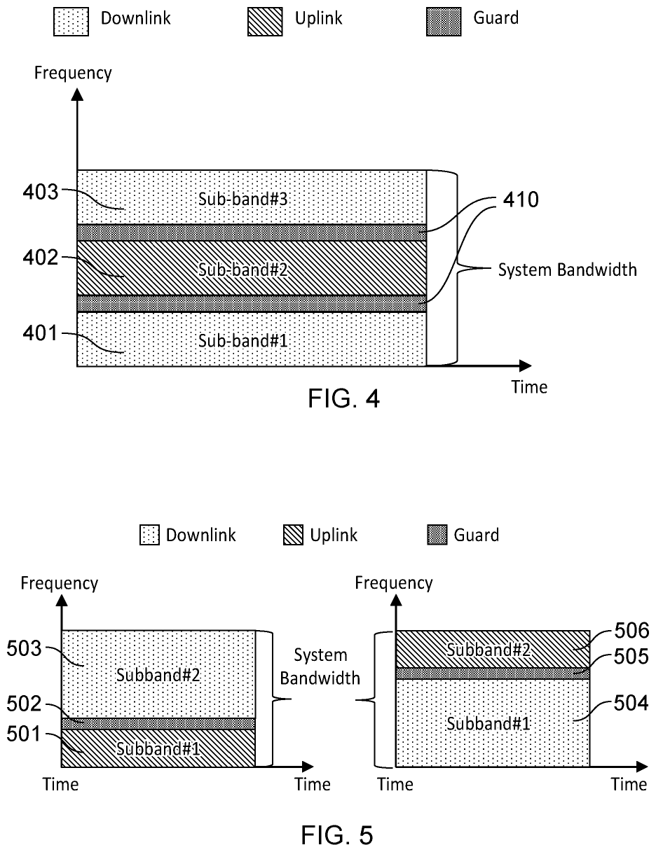

An example is shown in FIG. 4, where simultaneous DL and UL transmissions occur in different non-overlapping sub-bands 401 to 403, i.e. in different sets of frequency Resource Blocks (RB): Sub-band #1 401, Sub-band #2 402, Sub-band #3 such that Sub-band #1 401 and Sub-band #3 403 are used for DL transmissions whilst Sub-band #2 402 is used for UL transmissions.

While FIG. 4 shows the system bandwidth as being divided into three sub-bands, any number of sub-bands could be used. For example, the system bandwidth may be divided into four sub-bands, which may include the two downlink sub-bands 401, 403, the uplink sub-band 402 and another uplink subband, though other sub-band arrangements are envisioned. To reduce leakage from one sub-band 401 to 403 to another, a guard sub-band 410 may be configured between UL and DL sub-bands 401 to 403. Guard sub-bands 410 are configured between DL Sub-band #3 403 and UL Sub-band #2 402 and between UL Sub-band #2 402 and DL Sub-band #1 401.

The arrangement of sub-bands 401 to 403 shown in FIG. 4 is just one possible arrangement of the sub-bands and other arrangements are possible, and guard bands may be used in substantially any sub-band arrangement.

FIG. 5 shows two further examples with a DL and UL subband separated by a guard subband. For example, on the left-side of FIG. 5, a UL subband #1 501 is separated from a DL subband #2 503 by a guard subband 502. In this case, the DL subband #2 503 occupies a higher frequency portion of the system bandwidth than the UL subband #1 501. On the right-side of FIG. 5, a DL subband #1 504 is separated from a UL subband #2 506 by a guard subband 505. In this case, the UL subband #2 506 occupies a higher frequency portion of the system bandwidth than the DL subband #1 504.

### Intra-Cell Cross Link Interference (CLI) and Sub-Band Full Duplex (SBFD)

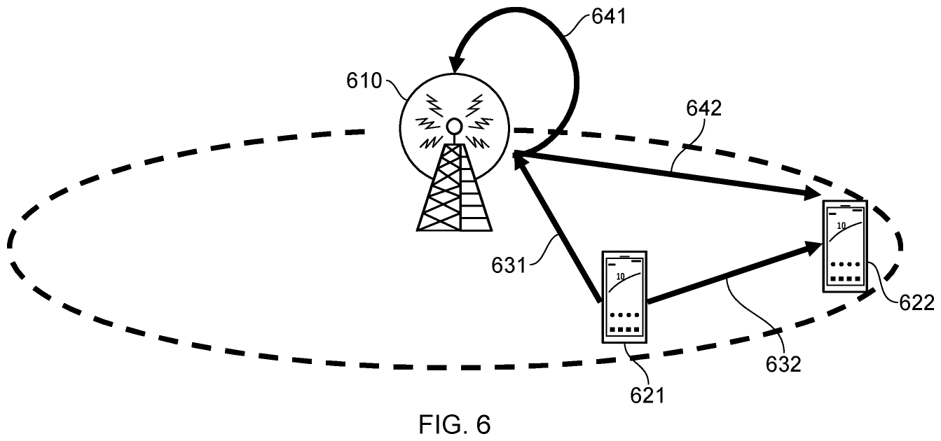

In addition to inter-cell CLI, FD-TDD also suffers from intra-cell CLI at the gNB and at the UE. An example is shown in FIG. 6, where a gNB 610 is capable of FD-TDD and is simultaneously receiving UL transmission 631 from UE1 621 and transmitting a DL transmission 642 to UE2 622. At the gNB 610, intra-cell CLI is caused by the DL transmission 642 at the gNB's transmitter self-interfering 641 with its own receiver that is trying to decode UL signals 631. At UE2 622, intra-cell CLI 632 is caused by an aggressor UE, e.g. UE1 621, transmitting in the UL 631, whilst a victim UE, e.g. UE2 622, is receiving a DL signal 642.

The intra-cell CLI at the gNB due to self-interference can be significant, as the DL transmission can in some cases be over 100 dB more powerful than the UL reception. Accordingly, complex RF hardware and interference cancellation are required to isolate this self-interference.

### Inter Sub-Band Interference

However, SBFD may suffer from inter sub-band interferences, which are caused by transmission leakage and receiver's selectivity. Although a transmission is typically scheduled within a specific frequency subband, i.e. a specific set of RBs, transmission power can leak out to other subbands. This occurs because subband filters are not perfect, and as such the roll-off of the filter will cause power to leak into subband adjacent to the intended specific frequency subband.

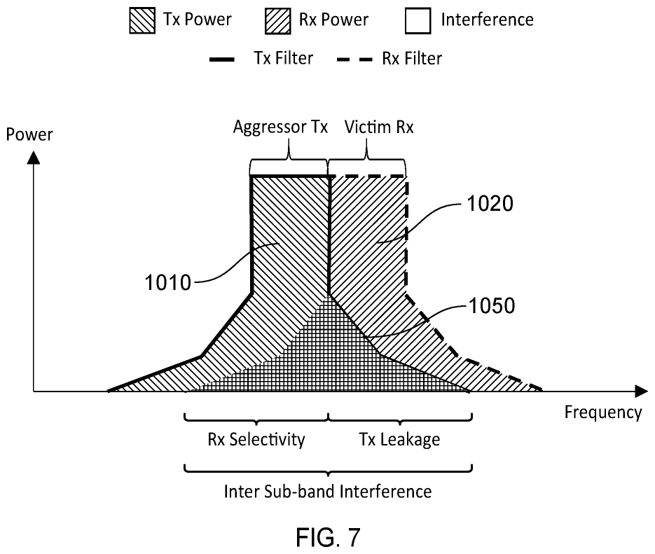

An example is shown in FIG. 7, where an aggressor transmits a signal in an adjacent subband 1010 at a lower frequency than the victim's receiving subband 1020. Due to roll-off of the transmission filter and nonlinearities in components of the transmitter, some transmission power is leaked into the victim's receiving subband 1020. Similarly, the receiver's filter is also not perfect and will receive unwanted power from the subband 1010. Therefore, the receiver will experience interference 1050.

### Synchronisation Signal Block (SSB)

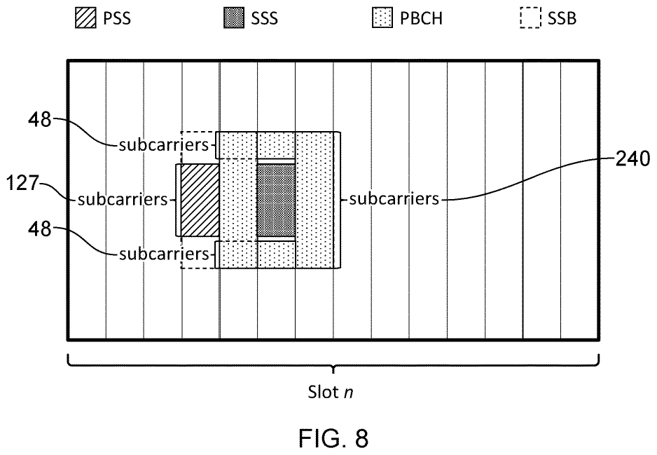

As will be known to one skilled in the art, the Synchronisation Signal Block (SSB) is used for initial access and cell reselection. An example of an SSB is schematically illustrated in FIG. 8.

As shown in FIG. 8, the SSB comprises of a Primary Synchronisation Signal (PSS), a Secondary Synchronisation Signal (SSS) and a Physical Broadcast Channel (PBCH). The SSB comprises information for a communications device, such as a UE, to detect, measure and access a cell. The SSB shown in FIG. 8 comprises 4 OFDM symbols and 240 subcarriers. The PSS and SSS each occupy 127 subcarriers. The PBCH occupies two OFDM symbols of 240 subcarriers and also 2 blocks of 48 subcarriers at the top and bottom of the SSS. The SSB may be configured with a periodicity, P_{SSB}, of between 5 ms and 160 ms.

An SSB burst set comprises a set of one or more time-multiplexed SSBs. Each SSB is transmitted in a burst set using a different beam, thereby enabling beam sweeping to be implemented for SSB. An SSB burst set may be confined within 5 ms and may comprise up to 4, 8 and 64 SSBs for frequency bands below 3 GHz, between 3 GHz-6 GHz and for FR2 respectively. As will be understood by one skilled in the art, SSB burst sets may be periodically transmitted.

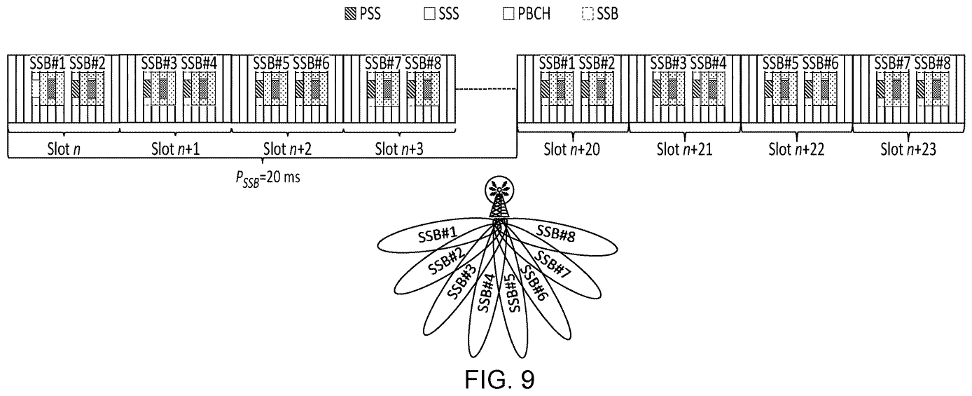

An example SSB burst set is shown in FIG. 9. The SSB burst set shown in FIG. 9 comprises 8 SSBs labelled as SSB #1, SSB #2, SSB #3, SSB #4, SSB #5, SSB #6, SSB #7 and SSB #8 respectively. Each of the SSBs in the burst set is transmitted using a different beam. In this example, 2 SSBs are configured per slot within 4 slots. Furthermore, the burst set is transmitted with a periodicity, P_{SSB}, of 20 ms. Although not shown in FIG. 9, the SSB burst set is transmitted by infrastructure equipment of a wireless communications network (such as a gNB) and received by a communications device (such as a UE).

The UE measures a signal quality of each SSB in the SSB burst set, The UE may then select one of the beams for data transmission or reception with the infrastructure equipment based on the measured signal quality. For example, the UE may select the beam on which the SSB with the highest measured signal quality was received. In initial access, the UE transmits its RACH using the selected beam. In one example, the measured signal quality of an SSB is an RSRP of the SSB. The UE may measure the RSRP of each SSB in the SSB burst set and select the beam on which the SSB with the highest RSRP was transmitted. Then, the UE transmits its RACH using the selected beam. In other examples, the UE does not select one of the beams for data transmission or reception following the measurement of the signal quality of each SSB in the SSB burst set. For example, the UE may transmit an indication of the measured quality of each SSB in the SSB burst set to the gNB. In this case, the gNB may select a beam for data transmission or reception with the UE based on the received indication. It will be appreciated that signal quality measurements of SSBs can be used for other purposes as will be known to one skilled in the art. In other words, the measurements of the signal quality of the SSBs may be used in for any process which relies on SSB signal quality measurement.

The measurement of the RSRP of an SSB may be referred to as “SS-RSRP”. The measurement of the RSRP of an SSB may comprise measuring the RSRP on resource elements where SSS is transmitted. Alternatively, or in addition, the measurement of the RSRP of an SSB may comprise measuring the RSRP on resource elements where PBCH DMRS is transmitted.

The measured signal quality of an SSB may be a Reference Signal Received Quality (SS-RSRQ) of the SSB. The SS-RSRQ is defined as the ratio of N×SS-RSRP/RSSI (Received Signal Strength Indicator), where N is the number of resource blocks. For example, the RSSI in NR is measured in one or more OFDM symbols in a SS/PBCH Block Measurement Time Configuration (SMTC). The SMTC is a configuration to the UE to set time window for measurement by using SSB. The OFDM symbols used for RSSI measurement can be configured by higher layers.

In SBFD operation, one or more SSBs may be configured in SBFD OFDM symbols whilst one or more other SSBs may be configured in non-SBFD OFDM symbols. For example, an SSB transmitted on a first beam in a burst set may be received in SBFD OFDM symbols and an SSB transmitted on a second beam in the burst set may be received in non-SBFD OFDM symbols. In another example, an SSB received on a first beam in the first burst set may be received in SBFD OFDM symbols and an SSB received on the first beam in the second burst set may be received in non-SBFD OFDM symbols.

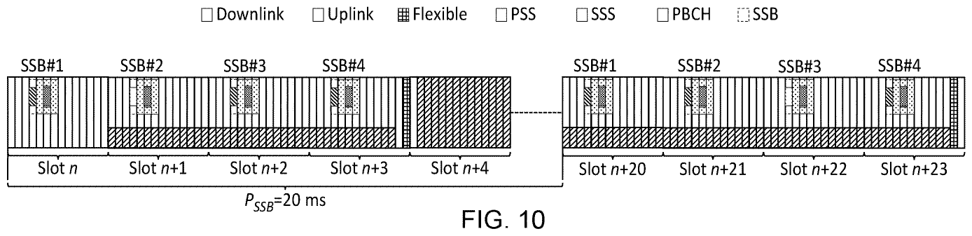

An example is shown in FIG. 10. As shown in FIG. 10, a plurality of SSB burst sets are transmitted, each comprising 4 SSBs, namely, SSB #1, SSB #2, SSB #3, SSB #4. The burst sets in FIG. 10 have a periodicity of 20 ms. A first of the burst sets is transmitted between Slot n to Slot n+3 and a second of the burst sets is transmitted between Slot n+20 to Slot n+23. As shown in FIG. 10, in the first burst set, SSB #1 is transmitted in non-SBFD OFDM symbols whereas SSB #2, SSB #3, SSB #4 are transmitted in SBFD OFDM symbols. In the second burst set, SSB #1, SSB #2, SSB #3, SSB #4 are transmitted in SBFD OFDM symbols.

An SSB in an SBFD slot (or SBFD OFDM symbols) may experience inter subband CLI whilst an SSB in non-SBFD slot (e.g., non-SBFD OFDM symbols such as DL OFDM symbols) does not experience inter subband CLI. This causes inconsistency in UE measurement of SSB signal quality (such as RSRP). This may negatively impact any process which relies on SSB signal quality measurements. For example, the UE may select a non-optimal beam for initial access and cell reselection based on the inconsistent measurements of SSB signal quality. For example, in FIG. 10, the beam on which SSB #2 may be the optimal beam because it is oriented most closely in the direction of the UE for example. However, in the first burst set between Slot n to Slot n+4, SSB #2 experiences inter subband CLI. Therefore, the RSRP of SSB #2 as measured by the UE may be lower than the RSRP of SSB #1 because SSB #1 is in non-SBFD OFDM symbols and therefore does not experience inter subband CLI. This may lead to the UE selecting to use the beam on which SSB #1 is transmitted as the beam for data transmission and reception with the infrastructure equipment. In other words, the UE selects a sub-optimal beam. Furthermore, if the UE measures the signal quality of an SSB transmitted on the same beam across multiple burst sets, it may obtain inconsistent measurements of the signal quality of the SSB. For example, in FIG. 10, SSB #1 is transmitted in non-SBFD OFDM symbols in the first burst set but is transmitted in SBFD OFDM symbols in the second burst set. Therefore, SSB #1 in the first burst set does not experience inter subband CLI whereas SSB #1 in the second burst set may experience inter subband CLI. Therefore, the UE may obtain different measurements of the signal quality of SSB #1 in the first burst set and the second burst set. As mentioned above, such inconsistency in SSB signal quality measurements may impact any process that require SSB signal quality measurements.

There is therefore a need for methods, communications devices and infrastructure equipment which can provide improved consistency and accuracy in SSB signal quality measurements.

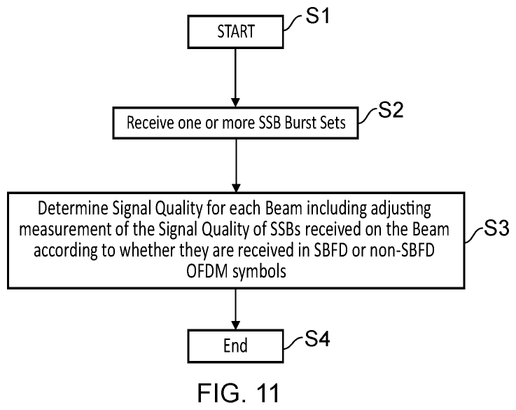

FIG. 11 illustrates a method of operating a communications device in accordance with example embodiments. The method starts in step S1.

In step S2, the method comprises receiving, from infrastructure equipment of a wireless communications network via a wireless access interface, one or more synchronisation signal block, SSB, burst sets. Each burst set comprises one or more SSBs. The one or more SSBs in each burst set are received on a respective one or more beams. The wireless access interface comprises a plurality of slots. Each of the plurality of slots comprises a plurality of Orthogonal Frequency Division Multiplexing, OFDM, symbols for receiving the one or more of SSBs in each burst set. One or more of the OFDM symbols are SBFD OFDM symbols and one or more of the OFDM symbols are non-SBFD OFDM symbols.

A non-SBFD OFDM symbol is an OFDM symbol which entirely is reserved for uplink transmissions (UL symbol) or downlink transmissions (DL symbol). An SBFD OFDM is an OFDM symbol which is partially reserved for uplink transmissions in the frequency domain and partially reserved for downlink transmissions in the frequency domain.

In some embodiments, the communications device is a UE and the infrastructure equipment is a gNB.

In step S3, the method comprises determining a signal quality for each beam based on a signal quality measurement of one or more of the SSBs received on the beam. In this step, the communications device adjusts the measurement of the signal quality of the one or more of SSBs received on the beam according to whether they are received in the plurality of SBFD OFDM symbols or the plurality of non-SBFD OFDM symbols.

In some embodiments, the adjustment of the measurement of the signal quality may refer to adjusting how the measurement of the signal quality is performed for SSBs received on a beam according to whether they are received in SBFD OFDM symbols or non-SBFD symbols. For example, the communications device may determine to only measure the signal quality of SBFD OFDM symbols or to only measure the signal quality of non-SBFD symbols.

In some embodiments, the adjustment of the measurement of the signal quality may refer to altering an already measured signal quality. For example, the communications device may apply an offset to a measured signal quality of SBFD OFDM symbols and/or apply an offset to a measured signal quality of non-SBFD OFDM symbols.

In accordance with example embodiments, the signal quality of an SSB may be an RSRP of the SSB, an RSRQ of the SSB or an SINR of the SSB.

The determined signal quality for a beam may be represented by a single signal quality value based on the signal quality measurement of the one or more SSBs received on the beam or may be represented by a set of signal quality values based on the signal quality measurement of the one or more SSBs received on the beam.

In step S4, the method ends.

As will be appreciated from an understanding of the example embodiments explained below, the adjustment of the measurement of the signal quality of one or more SSBs received on the beam according to whether they are received in the one or more SBFD OFDM symbols or the one or more non-SBFD OFDM symbols can provide an improvement in SSB measurement consistency and accuracy.

### Separate SSB Measurement Mechanisms

In some embodiments, separate measurement mechanisms are used for measuring the signal quality of SSBs in SBFD OFDM symbols and in non-SBFD OFDM symbols.

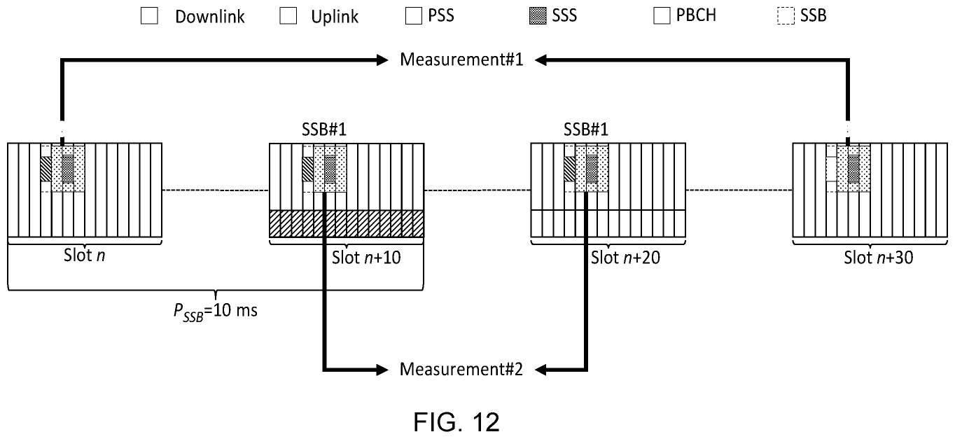

An example is shown in FIG. 12. FIG. 12 illustrates an SSB, SSB #1, which is transmitted on in the same beam in four consecutive burst sets. The burst sets have a periodicity of P_{SSB}=10 ms. As shown in FIG. 12, SSB #1 is transmitted in non-SBFD OFDM symbols in Slot n and Slot n+30, and SSB #1 is also transmitted in SBFD OFDM symbols in Slot n+10 and Slot n+20.

In accordance with example embodiments, the UE performs two separate measurements of the signal quality (Measurement #1 and Measurement #2) for SSB #1. Measurement #1 is performed on SSB #1 in the non-SBFD OFDM symbols and Measurement #2 is performed on SSB #1 in the SBFD OFDM symbols. The UE may then determine a signal quality for the beam on which SSB #1 is transmitted based on Measurement #1 and Measurement #2. The UE may report the two separate measurements of the signal quality (Measurements #1 and Measurement #2) for SSB #1 to the gNB as a determined signal quality of the beam.

In some embodiments, for example in initial access or cell reselection, the UE selects only SSBs received in non-SBFD OFDM symbols for signal quality measurement and excludes/drops SSBs received in SBFD OFDM symbols from signal quality measurement. Such embodiments remove the effects of inter subband CLI on SSB signal quality measurements. Therefore, the consistency and accuracy of SSB signal quality measurements is improved.

In some embodiments, for example in initial access or cell reselection, or anyother processes relying on SSB signal quality measurements, the UE selects only SSBs received in SBFD OFDM symbols for signal quality measurement and excludes SSBs received in non-SBFD OFDM symbols from signal quality measurement. Such embodiments are particularly advantageous when there are many configured SBFD OFDM symbols because, in these circumstances, the measured signal quality of the SSBs received in the SBFD OFDM symbols is more likely to be representative of the signal quality of the beam when data transmission or reception is being performed after beam selection. Therefore, the consistency and accuracy of SSB measurements is improved.

In some embodiments, the UE determines the inter subband CLI experienced by an SSB in SBFD OFDM symbols. For example, the UE may determine an inter-subband CLI based on a difference between the measured signal quality of one or more SSBs received on a beam in SBFD OFDM symbols and the measured signal quality of one or more SSBs received on the beam in non-SBFD OFDM symbols. For example, referring to FIG. 12, the UE may determine the inter subband CLI to be: Measurement #2-Measurement #1 in units such as dB. In this example, the signal quality measurements Measurement #1 and Measurement #2 are in dBm and may be a quantity such as RSRP. In other embodiments, the UE may determine the inter subband CLI to be: Measurement #2/Measurement #1. In this example, the signal quality measurements Measurement #1 and Measurement #2 may be in linear and may be a quantity such as SINR. In some embodiments, the UE may select the beam on which the SSB with the lowest inter subband CLI is received for data transmission or reception with the infrastructure equipment.

### Offset

In some embodiments, the UE changes a measured signal quality of SSBs received in SBFD OFDM symbols relative to a measured signal quality of the SSBs received in plurality of non-SBFD OFDM symbols by an offset. For example, the UE may increase or decrease a measured signal quality of SSBs received in SBFD OFDM symbols relative to a measured signal quality of the SSBs received in plurality of non-SBFD OFDM symbols by an offset. The relative change in the measured signal quality is achieved by modifying the measured signal quality of the SSBs received in SBFD OFDM symbols by an offset and/or modifying the measured signal quality of the SSBs received in non-SBFD OFDM symbols by an offset.

In some embodiments, separate offsets are applied to signal quality measurements of SSBs in SBFD OFDM symbols and signal quality measurements of SSBs in non-SFBD OFDM symbols. In other words, the UE applies an offset Δ_{SBFD} to signal quality measurements of SSBs in SBFD OFDM symbols and another offset Δ_{Non-SBFD} to signal quality measurements of SSBs in non-SBFD OFDM symbols. The application of an offset may refer to either the addition or the substraction of an offset. For example, the UE measures an RSRP_{SBFD}=X dBm for an SSB in SBFD OFDM symbols and RSRP_{Non-SBFD}=Y dBm for an SSB in non-SBFD OFDM symbols. Then, the UE calculates the effective RSRP for the signal quality of the SSB in the SBFD OFDM symbols as RSRP_{SSB}=X+Δ_{SBFD} dBm and the effective RSRP for the SSB measurement in non-SBFD OFDM symbols as RSRP_{SSB}=Y+Δ_{Non-SBFD} dBm. Here the UE treats the effective RSRP RSRP_{SSB} as the SSB RSRP and use this effective RSRP for initial access, cell reselection or any other process that relies on SSB signal quality measurements. Although this example assumes the offsets are in dB, this embodiment is also applicable for linear values. For example, scalar offsets can be applied on measurements in linear form such as SNIR ratios or signal strength in mW.

In some embodiments, the UE determines one or more weighting coefficients for one or more SSBs in SBFD symbols and one or more weighting coefficients for one or more SSBs in non-SBFD symbols. In such embodiments, the UE may determine a weighted average signal quality by weighting measurements of the signal quality of SSBs in SBFD OFDM symbols with the weighting coefficients for the SSBs in the SBFD OFDM symbols and weighting measurements of the signal quality of SSBs in non-SBFD OFDM symbols with the weighting coefficients for the SSBs in the non-SBFD OFDM symbols. In some embodiments, the weighting coefficients for the SSBs in the SBFD OFDM symbols is the offset, Δ_{SBFD}, and the weighting coefficients for the SSBs in the non-SBFD OFDM symbols is the offset, Δ_{Non-SBFD}. For example, the UE measures an RSRP_{SBFD}=X dBm for an SSB in SBFD OFDM symbols and RSRP_{Non-SBFD}=Y dBm for an SSB in non-SBFD OFDM symbols. The weighted average is therefore RSRPAverage=Δ_{SBFD} X+Δ_{Non-SBFD} Y dBm.

In some embodiments, the UE performs N_{SBDF} measurements of the signal quality for an SSB in SBFD OFDM symbols and N_{Non-SBDF} measurements of the signal quality for an SSB in non-SBFD OFDM symbols. In some embodiments, the UE applies the offset Δ_{SBFD} to each one of the N_{SBDF} measurements and applies the offset Δ_{Non-SBFD} to each one of the N_{Non-SBDF} measurements. In some embodiments, the UE determines the average of the N_{SBDF} measurements and applies the offset Δ_{SBFD} to the average of the N_{SBDF} measurements and also determines the average if the N_{Non-SBDF} measurements and applies the offset Δ_{Non-SBFD} to the average of the N_{Non-SBDF} measurements.

In some embodiments, the UE determines a transmit power of the SSBs received in SBFD OFDM symbols and determines the offset based on the transmit power. Such embodiments are particularly advantageous when the gNB boosts the transmit power of an SSB in SBFD OFDM symbols to overcome the inter subband CLI. In one example, if 3 dB power boosting is applied to an SSB in SBFD OFDM symbols, then Δ_{SBFD} may be set to 0 dB and if 0 dB power boosting is applied to an SSB in SBFD OFDM symbols, then Δ_{SBFD} may set to 3 dB.

In some embodiments, the offsets Δ_{SBFD} and Δ_{Non-SBFD} are signaled to the UE by the gNB via RRC, such as in SIBs.

In some embodiments, the offsets Δ_{SBFD} and Δ_{Non-SBFD} are predefined in the specifications. Therefore, the offsets are known to the UE.

In some embodiments, for example when the offsets are predefined in the specifications, the offsets are calculated using a formula. For example, if in a predefined time window for SSB #1, there are X_{SBFD} SSB #1 in SBFD OFDM symbols and X_{Non-SBDF} SSB #1 in non-SBFD OFDM symbols, then the UE calculates Δ_{SBFD}=αX_{SBFD}/X_{Non-SBDF} in linear terms or Δ_{SBFD}=log₁₀ (αX_{SBFD}/X_{Non-SBDF}) in dB terms, where a can be determined from the specifications or signaled in SIB. In some cases, α=1.

In some embodiments, the formula for the offsets can be the percentage of SSB in SBFD OFDM symbols and the percentage of SSB in non-SBFD OFDM symbols. For example, if there are X_{SBFD} SSB #1 in SBFD OFDM symbols and X_{Non-SBDF} SSB #1 in non-SBFD OFDM symbols, then the UE calculates Δ_{SBFD}=αX_{SBFD}/X_{SBFD}+X_{Non-SBDF} in linear terms or Δ_{SBFD}=log₁₀ (αX_{SBFD}/X_{SBFD}+X_{Non-SBDF}) in dB terms, and Δ_{Non-SBFD}=αX_{Non-SBDF}/X_{SBFD}+X_{Non-SBDF} in linear terms or Δ_{Non-SBFD}=log₁₀ (αX_{Non-SBDF}/X_{SBFD}+X_{Non-SBFD}) in dB, where α can be determined from the specifications or signaled in the SIB. In some cases, α=1.

In some embodiments, the UE determines the offsets based on the inter subband CLI experienced by the SSB. The inter subband CLI can be obtained using separate measurements for SSB in SBFD OFDM symbols and non-SBFD OFDM symbols. For example, the UE determines the average inter subband CLI over a known time period to be I_{CLI} dBm and therefore can calculate Δ_{SBFD}=β+I_{CLI} dB, where β can be predefined in the specifications or signaled in the SIBs.

In some embodiments, the offset, Δ_{Non-SBFD}, for measurements of the signal quality of an SSB in non-SBFD OFDM symbols is zero in dB terms and 1 in linear terms. That is, the UE does not apply any offset to measurements of the signal quality of an SSB in non-SBFD OFDM symbols or the, Δ_{Non-SBFD}, is not implemented by the network, and only applies an offset to measurements of the signal quality if an SSB is in SBFD OFDM symbols.

Although references are made above to using offsets Δ_{SBFD} and Δ_{Non-SBDF} to change a measured signal quality of SSBs in SBFD OFDM symbols relative to a measured signal quality of SSBs in non-SBFD OFDM symbols, it will be appreciated that the same relative change can be achieved by using only one of the offsets. For example, a relative increase in the measured signal quality of SSBs in SBFD OFDM symbols relative to a measured signal quality of SSBs in non-SBFD OFDM symbols of 3 dB can be achieved by adding Δ_{SBFD}=3 dB to the measured signal quality of an SSB in SBFD OFDM symbols, or by adding Δ_{SBFD}=2 dB to the measured signal quality of the SSB in SBFD OFDM symbols and subtracting Δ_{Non-SBFD}=−1 dB from the measured signal quality of an SSB in the non-SBFD OFDM symbols.

### SSB Partially Overlaps SBFD OFDM Symbols

In some configurations, only a part of an SSB is transmitted in SBFD OFDM symbols. For example, only a subset of the OFDM symbols forming the SSB are SBFD symbols, while the other OFDM symbols forming the SSB are non-SBFD symbols (such as DL symbols).

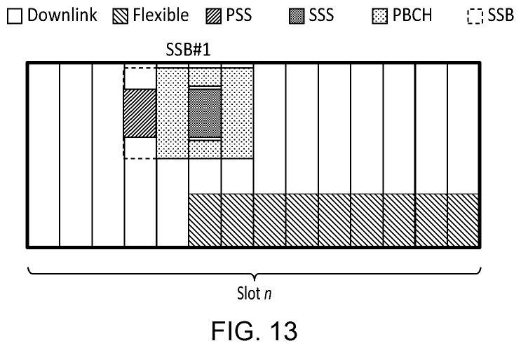

An example is shown in FIG. 13. As shown in FIG. 13, SSB #1 is transmitted in SBFD slot n. Two of the OFDM symbols of SSB #1 comprising PSS and PBCH are transmitted in DL OFDM symbols (i.e. non-SBFD OFDM symbols). The remaining OFDM symbols of SSB #1 comprising SSS and PBCH are transmitted in SBFD OFDM symbols.

In some embodiments, separate signal quality measurements are performed on SSBs that are fully in SBFD OFDM symbols, SSBs that are partially in SBFD OFDM symbols and SSBs that are fully in non-SBFD OFDM symbols. For example, an SSB may be transmitted on a beam fully in SBFD OFDM symbols in a first burst set, transmitted on the beam partially in SBFD symbols in a second burst set and transmitted on the beam fully in non-SBFD symbols in a third burst set. In other words, three separate measurements are performed on a particular SSB. The UE may determine the signal quality of the beam based on the three measurements.

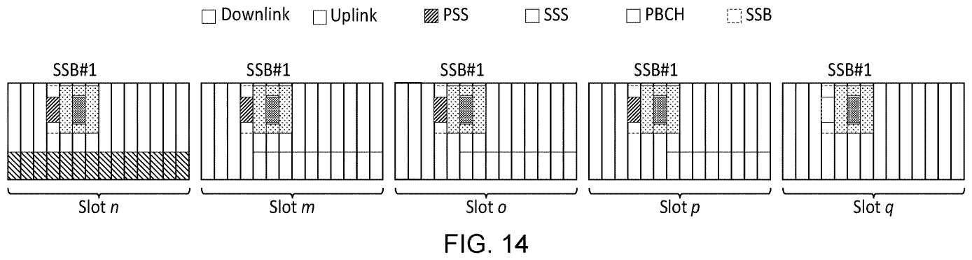

In some embodiments, separate measurements are performed on SSBs for different levels of overlap with SBFD OFDM symbols. For example, there may be up to 5 different measurements of the signal quality of an SSB transmitted on a particular beam over 5 burst sets. In particular, the SSB may be transmitted fully in SBFD OFDM symbols in a first burst set, transmitted in 3 SBFD OFDM symbols and 1 non-SBFD OFDM symbols in a second burst set, transmitted in 2 SBFD OFDM symbols and 2 non-SBFD OFDM symbols in a third burst set, transmitted in 1 SBFD OFDM symbol overlap and 3 non-SBFD OFDM symbols in a fourth burst set and transmitted fully in non-SBFD OFDM symbols in a fifth burst set. Such an example is shown for SSB #1 in Slot n, Slot m, Slot o, Slot p and Slot q respectively in FIG. 14 for SSB #1. In such embodiments, the UE performs a signal quality measurement on SSB #1 in Slot n, Slot m, Slot o, Slot p and Slot q. The UE may then determine the signal quality of the beam on which SSB #1 is transmitted based on the measurements.

In some embodiments, the number of measurements of a particular SSB depends on whether the PSS and/or SSS are transmitted in SBFD or non-SBFD OFDM symbols. For example, an SSB may be transmitted on a particular beam over 4 burst sets. In the first burst set, the PSS and SSS of the SSB are transmitted in SBFD OFDM symbols. In the second burst set, the PSS of the SSB is transmitted in an SBFD OFDM symbol and the SSS of the SSB is transmitted in a non-SBFD OFDM symbol. In the third burst set, the PSS of the SSB is transmitted in a non-SBFD OFDM symbol and the SSS of the SSB is transmitted in an SBFD OFDM symbol. In the fourth burst set, the PSS and SSS of the SSB are transmitted in non-SBFD OFDM symbols. In such embodiments, the UE performs a signal quality measurement of the SSB in each of the 4 burst sets. The UE may then determine the signal quality of the beam on which SSB #1 is transmitted based on the measurements. These measurements do not consider whether PBCH is in SBFD OFDM symbols or non-SBFD OFDM symbols. Such embodiments recognise that PSS and SSS are typically used for measurements of the signal quality of an SSB and hence whether they are in SBFD OFDM symbol or non-SBFD OFDM symbol affects the signal quality measurements.

In some embodiments, different offsets are applied to signal quality measurements for SSBs with a different number of OFDM symbols overlapping SBFD OFDM symbols.

In some embodiments, different offsets are applied to signal quality measurements for SSBs depending on whether the PSS and/or SSS overlaps with SBFD OFDM symbols.

In some embodiments, the measurements taken from an SSB that partially overlaps in time with SBFD OFDM symbols are excluded from signal quality measurement.

In some embodiments, if the SSS of an SSB is transmitted in an SBFD OFDM symbol, then the signal quality measurement of the SSB is performed assuming the entire SSB is transmitted in SBFD OFDM symbols. On the other hand, if the SSS is in a non-SBFD OFDM symbol, the signal quality measurement of the SSB is performed assuming the entire SSB is transmitted in non-SBFD OFDM symbols. In such embodiments, only the SSS is used for signal quality measurement of an SSB. Therefore, only the SSS have an effect on the signal quality measurement results.

In some embodiments, if the PSS of an SSB is transmitted in an SBFD OFDM symbol, then the signal quality measurement of the SSB is performed assuming the entire SSB is transmitted in SBFD OFDM symbols. On the other hand, if the PSS is in a non-SBFD OFDM symbol, the signal quality measurement of the SSB is performed assuming the entire SSB is transmitted in non-SBFD OFDM symbols. In such embodiments, only the PSS is used for measurement of an SSB. Therefore only the PSS have an effect on the signal quality measurement.

RE Elimination from Measurement Calculation

In some embodiments, the UE performs signal quality measurement on a part of the SSB in the SBFD slot which is further from the boundary between the uplink and the downlink region than the other part of the SSB on which signal quality measurement is not performed. Such embodiments effectively remove resource elements from the signal quality measurement which are likely to have a higher impact on CLI.

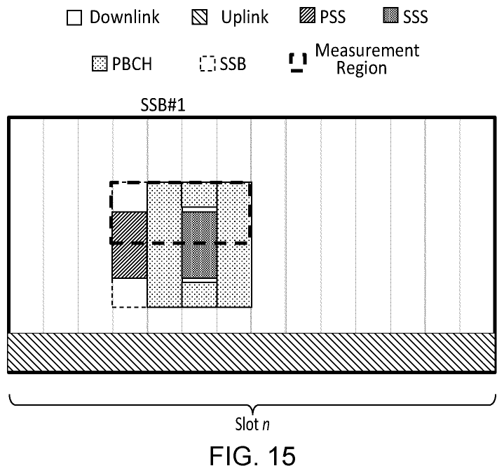

An example is shown in FIG. 15. An upper half of SSB further from the UL subband than the lower half is designated as a measurement region. The upper half of the SSB is likely to be less impacted by CLI because it is further from the UL region. In accordance with example embodiments, the UE measures the signal quality of the SSB by performing signal quality measurements only in the measurement region. Therefore, the part of the SSB more likely to be affected by CLI are excluded from the measurement, thereby improving SSB measurement accuracy and consistency.

In some embodiments, REs or subcarriers which are used signal quality measurement (such as for SS-RSRP and SS-RSRQ measurement) are indicated by a higher layer (RRC or SIB).

In some embodiments, REs or subcarriers which are used for signal quality measurement (for example, SS-RSRP and SS-RSRQ measurement) are determined by a frequency gap between these REs and UL subband. For example, REs on an SSB can be used for SS-RSRP and SS-RSRQ measurement if distance between these REs and UL subband exceeds the pre-determined threshold. The pre-determined threshold can be defined by specification or configured by a higher layer.

In some embodiments, REs or subcarriers which are used for signal quality measurement (such as SS-RSRP and SS-RSRQ measurement) are determined by a UE based on a result of inter subband CLI measurement. For example, if CLI-RSRP exceeds over the certain threshold, some REs which is close to UL subband are not used for SS-RSRP and SS-RSRQ measurement. On the other hand, if CLI-RSRP is below the certain threshold, all REs on SSB can be used for SS-RSRP and SS-RSRQ measurement. The certain threshold to determine measured REs on SSB can be defined by specification or configured by a higher layer.

The following numbered paragraphs provide further example aspects and features of the present technique:

Paragraph 1. A method of operating a communications device, the method comprising
receiving, from infrastructure equipment of a wireless communications network via a wireless access interface, one or more synchronisation signal block, SSB, burst sets, each burst set comprising one or more SSBs, the one or more SSBs in each burst set being received on a respective one or more beams, wherein the wireless access interface comprises a plurality of slots, each of the plurality of slots comprising a plurality of Orthogonal Frequency Division Multiplexing, OFDM, symbols for receiving the one or more of SSBs in each burst set, one or more of the OFDM symbols being SBFD OFDM symbols and one or more of the OFDM symbols being non-SBFD OFDM symbols,
determining a signal quality for each beam based on a signal quality measurement of one or more of the SSBs received on the beam including adjusting the measurement of the signal quality of the one or more of SSBs received on the beam according to whether they are received in the plurality of SBFD OFDM symbols or the plurality of non-SBFD OFDM symbols.

Paragraph 2. A method according to paragraph 1, wherein the adjusting the measurement of the signal quality of the one or more of the SSBs received on the beam according to whether they are received in the plurality of SBFD OFDM symbols or the plurality of non-SBFD OFDM symbols comprises
selecting the SSBs received on the beam in the plurality of non-SBFD OFDM symbols for signal quality measurement and excluding the SSBs received on the beam in the plurality of SBFD OFDM symbols from signal quality measurement.

Paragraph 3. A method according to paragraph 1, wherein the adjusting the measurement of the signal quality of the one or more of the SSBs received on the beam according to whether they are received in the plurality of SBFD OFDM symbols or the plurality of non-SBFD OFDM symbols comprises
selecting the SSBs received on the beam in the plurality of SBFD OFDM symbols for signal quality measurement and excluding the SSBs received on the beam in the plurality of non-SBFD OFDM symbols from signal quality measurement.

Paragraph 4. A method according to paragraph 1, wherein the adjusting the measurement of the signal quality of the one or more of the SSBs received on the beam according to whether they are received in the plurality of SBFD OFDM symbols or the plurality of non-SBFD OFDM symbols comprises
measuring a signal quality of one or more of the SSBs received on the beam in the plurality of SBFD OFDM symbols,
measuring a signal quality of one or more of the SSBs received on the beam in the plurality of non-SBFD OFDM symbols,
determining an inter-subband cross link interference, CLI, based on a difference between the measured signal quality of the one or more SSB received on the beam in the plurality of SBFD OFDM symbols and the measured signal quality of the one or more SSBs received on the beam in the plurality of non-SBFD OFDM symbols, wherein the determining the signal quality for each beam comprises
determining the signal quality for each beam based on the determined inter-subband CLI for each beam.

Paragraph 5. A method according to paragraph 1, wherein the adjusting the signal quality measurement of the one or more SSBs received on the beam according to whether they are received in the plurality of SBFD OFDM symbols or the plurality of non-SBFD OFDM symbols comprises
changing a measured signal quality of the SSBs received in the plurality of SBFD OFDM symbols relative to a measured signal quality of the SSBs received in the plurality of non-SBFD OFDM symbols by an offset, Δ_{SBFD}.

Paragraph 6. A method according to paragraph 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
applying the offset to the measured signal quality of each of the SSBs received in the plurality of SBFD OFDM symbols.

Paragraph 7. A method according to paragraph 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining an average of the measured signal quality of each of the SSBs received in the plurality of SBFD OFDM symbols,
applying the offset to the average measured signal quality of the SSBs received in the plurality of SBFD OFDM symbols.

Paragraph 8. A method according to paragraph 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
multiplying the measured signal quality of each of the SSBs received in the plurality of SBFD OFDM symbols by the offset.

Paragraph 9. A method according to paragraph 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining an average of the measured signal quality of each of the SSBs received in the plurality of SBFD OFDM symbols,
multiplying the average measured signal quality of each of the SSBs received in the plurality of SBFD OFDM symbols by the offset.

Paragraph 10. A method according to any of paragraphs 5 to 9, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining a transmit power of the SSBs received in SBFD OFDM symbols and determining the offset based on the transmit power.

Paragraph 11. A method according to any of paragraphs 5 to 9, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining a number of the SSBs received in the SBFD OFDM symbols within a predefined time window,
determining a number of the SSBs received in the non-SBFD OFDM symbols within the predefined time window,
determining the offset based on a ratio of the number of the SSBs received in the SBFD OFDM symbols, X_{SBFD}, within the predefined time window and the number of the SSBs received in the non-SBFD OFDM symbols, X_{Non-SBFD}, within the predefined time window.

Paragraph 12. A method according to paragraph 11, wherein the offset is determined according to Δ_{SBFD}=αX_{SBFD}/X_{Non-SBDF}, where α is a number.

Paragraph 13. A method according to paragraph 11, wherein the offset is determined according to Δ_{SBFD}=log₁₀ (αX_{SBFD}/X_{Non-SBDF}), where α is a number.

Paragraph 14. A method according to any of paragraphs 5 to 9, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining a number of the SSBs received in the SBFD OFDM symbols within a predefined time window,
determining a number of the SSBs received in the non-SBFD OFDM symbols within the predefined time window,
determining the offset based on a ratio of the number of the SSBs received in the SBFD OFDM symbols, X_{SBFD}, within the predefined time window to the sum of the number of the SSBs received in the SBFD OFDM symbols, X_{SBFD}, within the predefined time window and the number of the SSBs received in the non-SBFD OFDM symbols, X_{Non-SBFD}, within the predefined time window.

Paragraph 15. A method according to paragraph 14, wherein the offset is determined according to Δ_{SBFD}=αX_{SBFD}/X_{SBFD}/X_{Non-SBDF}, where α is a number.

Paragraph 16. A method according to paragraph 14, wherein the offset is determined according to Δ_{SBFD}=log₁₀ (αX_{SBFD}/X_{SBFD}+X_{Non-SBDF}), where α is a number.

Paragraph 17. A method according to any of paragraphs 12, 13, 15 or 16, wherein the number, a, is received in a system information block, SIB, from the infrastructure equipment or fixed in the specifications.

Paragraph 18. A method according to paragraph 5, wherein the increasing the measured signal quality of the SSBs received in the plurality of SBFD OFDM symbols relative to the measured signal quality of the SSBs received in the plurality of non-SBFD OFDM symbols by the offset, Δ_{SBFD}, comprises
measuring a signal quality of the SSBs received on the beam in the SBFD OFDM symbols,
measuring a signal quality of the SSBs received on the beam in the non-SBFD OFDM symbols,
determining an inter-subband cross link interference, CLI, I_{CLI}, based on a difference between the measured signal quality of the SSBs received on the beam in in the SBFD OFDM symbols and the measured signal quality of the SSBs received on the beam in the non-SBFD OFDM symbols, and
determining the offset based on the determined inter subband CLI.

Paragraph 19. A method according to paragraph 18, wherein the comprising the offset based on the determined inter subband CLI comprises
determining offset according to Δ_{SBFD}=β+I_{CLI}, where β is a number.

Paragraph 20. A method according to paragraph 19, wherein the β is received from the infrastructure equipment in a system information block, SIB, or fixed in the specifications.

Paragraph 21. A method according to any of paragraphs 5 to 18, wherein the offset is received in a Radio Resource Control, RRC, signal from the infrastructure equipment.

Paragraph 22. A method according to paragraph 21, wherein the RRC signal comprises a system information block, SIB, including the offset.

Paragraph 23. A method according to any of paragraphs 5 to 18, wherein the offset is fixed in the specifications.

Paragraph 24. A method according to paragraph 1, wherein the adjusting the signal quality measurement of the one or more SSBs received on the beam according to whether they are received in the plurality of SBFD OFDM symbols or the plurality of non-SBFD OFDM symbols comprises
measuring a signal quality of one or more of the SSBs received on the beam in the plurality of SBFD OFDM symbols,
measuring a signal quality of one or more of the SSBs received on the beam in the plurality of non-SBFD OFDM symbols,
determining one or more weighting coefficients for the one or more SSBs received on the beam in the SBFD OFDM symbols and one or more weighting coefficients for the one or more SSBs received on the beam in the non-SBFD OFDM symbols,
determining a weighted average signal quality of the measured signal quality of the one or more of the SSBs received on the beam in the SBFD OFDM symbols and the one or more of the SSBs received on the beam in the non-SBFD OFDM symbols, the determining the weighted average signal quality comprising weighting the measured signal quality of the SSBs in the SBFD OFDM symbols with the weighting coefficients for the SSBs in the SBFD OFDM symbols and weighting the measured signal quality of the SSBs in the non-SBFD OFDM symbols with the weighting coefficients for the SSBs in the non-SBFD OFDM symbols, wherein the weighted average signal quality is the determined signal quality of the beam.

Paragraph 25. A method according to paragraph 1, wherein the adjusting the measurement of the signal quality of one or more SSBs received on the beam according to whether they are received in the plurality of SBFD OFDM symbols or the plurality of non-SBFD OFDM symbols comprises
determining that a plurality of SSBs are received on the beam,
determining that the plurality of SSBs received on the beam overlap with non-SBFD OFDM symbols to differing extents,
selecting one or more of the plurality of SSBs received on the beam for signal measurement based on the extent to which the SBFDs overlap with the non-SBFD OFDM symbols.

Paragraph 26. A method according to paragraph 1, wherein the SBFD OFDM symbols comprise an uplink region reserved for uplink communications resources and a downlink region reserved for downlink communications resources, the uplink and downlink regions being separated by a boundary.

Paragraph 27. A method according to paragraph 26, wherein the adjusting the measurement of the signal quality of one or more SSBs received on the beam according to whether they are received in the plurality of SBFD OFDM symbols or the plurality of non-SBFD OFDM symbols comprises
performing signal quality measurement on a part of the SSBs in the SBFD OFDM symbols which is further from the boundary between the uplink and the downlink region than the other part of the SSB.

Paragraph 28. A method according to paragraph 27, wherein the part of the SSB in the SBFD OFDM symbols which is further from the boundary between the uplink and the downlink region is indicated to the communications device in a Radio Resource Control, RRC, signal from the infrastructure equipment.

Paragraph 29. A method according to paragraph 28, the RRC signal comprises a system information block, SIB, indicating the part of the SSB in the SBFD OFDM symbols which is further from the boundary between the uplink and the downlink region.

Paragraph 30. A method according to paragraph 29, wherein the part of the SSB in the SBFD OFDM symbols which is further from the boundary between the uplink and the downlink region is determined by the communications device based on a predefined time and/or frequency threshold.

Paragraph 31. A method according to paragraph 30, wherein the predefined time and/or frequency threshold is received by the communications device from the infrastructure equipment or fixed in the specifications.

Paragraph 32. A method according to paragraph 27, wherein the performing signal quality measurement on the part of the SSB in the SBFD OFDM symbols which is further from the boundary between the uplink and the downlink region comprises
measuring a signal quality of one or more of the SSBs received on the beam in the SBFD OFDM symbols,
measuring a signal quality of one or more of the SSBs received on the beam in the non-SBFD OFDM symbols,
determining an inter-subband cross link interference, CLI, based on a difference between the measured signal quality of the one or more SSBs received on the beam in the SBFD OFDM symbols and the measured signal quality of the one or more SSBs received on the beam in the non-SFD OFDM symbols,
determining that the inter-CLI is above a threshold,
determining to measure the part of the SSB in the SBFD slot which is further from the boundary between the uplink and the downlink region, wherein the determining the signal quality for each beam comprises
determining the signal quality for each beam based on the determined inter-subband CLI for each beam.

Paragraph 33. A method according to any of paragraph 1 or paragraphs 4 to 32, wherein the adjusting the signal quality measurement of the one or more SSBs received on the beam according to whether they are received in the plurality of SBFD OFDM symbols or the plurality of non-SBFD OFDM symbols comprises
performing a first measurement of a signal quality of one or more of the SSBs received on the beam in the plurality of SBFD OFDM symbols,
performing a second measurement of a signal quality of one or more of the SSBs received on the beam in the plurality of non-SBFD OFDM symbols, wherein the first measurement is performed separately from the second measurement.

Paragraph 34. A method according to any of paragraphs 1 to 33, comprising
selecting one of the one or more beams for data transmission or reception with the infrastructure equipment based on the determined signal quality for each beam.

Paragraph 35. A method operating infrastructure equipment of a wireless communications network, the method comprising
transmitting, to a communications of a wireless communications network via a wireless access interface, one or more synchronisation signal block, SSB, burst sets, each burst set comprising one or more SSBs, the one or more SSBs in each burst set being transmitted on a respective one or more beams, wherein the wireless access interface comprises a plurality of slots, each of the plurality of slots comprising a plurality of Orthogonal Frequency Division Multiplexing, OFDM, symbols for transmitting the plurality of SSBs in each burst set, one or more of the OFDM symbols being SBFD OFDM symbols and one or more of the OFDM symbols being non-SBFD OFDM symbols,
transmitting, to the communications device, information for the communications device to determine, for each beam, how to adjust a signal quality measurement of one or more of the SSBs received on the beam according to whether the SSBs are received in the plurality of SBFD OFDM symbols or the plurality of non-SBFD OFDM symbols.

Paragraph 36. A method according to paragraph 35, wherein the information comprises an indication of an offset, Δ_{SBFD}, by which the communications device should change a measured signal quality of the SSBs received in the plurality of SBFD OFDM symbols relative to a measured signal quality of the SSBs received in the plurality of non-SBFD OFDM symbols by an offset.

Paragraph 37. A method according to paragraph 36, wherein the information comprises an indication of a transmit power of the SSBs transmitted by the infrastructure equipment.

Paragraph 38. A method according to paragraph 36, wherein the information comprises an indication of number, α, for the communications device to determine the offset, Δ_{SBFD}, according to

$${Δ}_{SBFD} = α \frac{{X}_{SBFD}}{{X}_{Non - SBFD}} ,$$

$${Δ}_{SBFD} = {log}_{10} ( α \frac{{X}_{SBFD}}{{X}_{Non - SBFD}} ) ,$$

$${Δ}_{SBFD} = α \frac{{X}_{SBFD}}{{X}_{SBFD} + {X}_{Non - SBFD}}$$

$$or$$

$${Δ}_{SBFD} = {log}_{10} ( α \frac{{X}_{SBFD}}{{X}_{SBFD} + {X}_{Non - SBFD}} ) .$$

Paragraph 39. A method according to paragraph 36, wherein the information comprises an indication of a number, β, for the communications device to determine the offset, Δ_{SBFD}, according to Δ_{SBFD}=β+I_{CLI}, where I_{CLI} is an inter-subband cross-link interference determined by the communications device.

Paragraph 40. A method according to paragraph 35, wherein the information comprises an indication of one or more weighting coefficients for the one or more SSBs received on the beam in the SBFD OFDM symbols and one or more weighting coefficients for the one or more SSBs received on the beam in the non-SBFD OFDM symbols for the communications device to determine a weighted average signal quality of the measured signal quality of the one or more of the SSBs received on the beam in the plurality of SBFD OFDM symbols and the one or more of the SSBs received on the beam in the plurality of non-SBFD OFDM symbols.

Paragraph 41. A method according to any of paragraphs 35 to 40, wherein the information is transmitted in a Radio Resource Control, RRC, signal.

Paragraph 42. A method according to paragraph 41, wherein the information is transmitted in a system information block, SIB.

Paragraph 43. A communications device comprising
a transmitter configured to transmit signals,
a receiver configured to receive signals, and
a controller configured in combination with the transmitter and the receiver to
receive, from infrastructure equipment of a wireless communications network via a wireless access interface, one or more synchronisation signal block, SSB, burst sets, each burst set comprising one or more SSBs, the one or more SSBs in each burst set being received on a respective one or more beams, wherein the wireless access interface comprises a plurality of slots, each of the plurality of slots comprising a plurality of Orthogonal Frequency Division Multiplexing, OFDM, symbols for receiving the one or more of SSBs in each burst set, one or more of the OFDM symbols being SBFD OFDM symbols and one or more of the OFDM symbols being non-SBFD OFDM symbols, and
determine a signal quality for each beam based on a signal quality measurement of one or more of the SSBs received on the beam including adjusting the measurement of the signal quality of the one or more of SSBs received on the beam according to whether they are received in the plurality of SBFD OFDM symbols or the plurality of non-SBFD OFDM symbols.

Paragraph 44. Infrastructure equipment for a wireless communications network, the infrastructure equipment comprising
a transmitter configured to transmit signals,
a receiver configured to receive signals, and
a controller configured in combination with the transmitter and the receiver to
transmit, to a communications of a wireless communications network via a wireless access interface, one or more synchronisation signal block, SSB, burst sets, each burst set comprising one or more SSBs, the one or more SSBs in each burst set being transmitted on a respective one or more beams, wherein the wireless access interface comprises a plurality of slots, each of the plurality of slots comprising a plurality of Orthogonal Frequency Division Multiplexing, OFDM, symbols for transmitting the plurality of SSBs in each burst set, one or more of the OFDM symbols being SBFD OFDM symbols and one or more of the OFDM symbols being non-SBFD OFDM symbols, and
transmit, to the communications device, information for the communications device to determine, for each beam, how to adjust a signal quality measurement of one or more of the SSBs received on the beam according to whether the SSBs are received in the plurality of SBFD OFDM symbols or the plurality of non-SBFD OFDM symbols.

Paragraph 45. Circuitry for a communications device, the circuitry comprising
transmitter circuitry configured to transmit signals,
receiver circuitry configured to receive signals, and
controller circuitry configured in combination with the transmitter circuitry and the receiver circuitry to
receive, from infrastructure equipment of a wireless communications network via a wireless access interface, one or more synchronisation signal block, SSB, burst sets, each burst set comprising one or more SSBs, the one or more SSBs in each burst set being received on a respective one or more beams, wherein the wireless access interface comprises a plurality of slots, each of the plurality of slots comprising a plurality of Orthogonal Frequency Division Multiplexing, OFDM, symbols for receiving the one or more of SSBs in each burst set, one or more of the OFDM symbols being SBFD OFDM symbols and one or more of the OFDM symbols being non-SBFD OFDM symbols, and
determine a signal quality for each beam based on a signal quality measurement of one or more of the SSBs received on the beam including adjusting the measurement of the signal quality of the one or more of SSBs received on the beam according to whether they are received in the plurality of SBFD OFDM symbols or the plurality of non-SBFD OFDM symbols.

Paragraph 46. Circuitry for infrastructure equipment for a wireless communications network, the circuitry comprising
transmitter circuitry configured to transmit signals,
receiver circuitry configured to receive signals, and
controller circuitry configured in combination with the transmitter circuitry and the receiver circuitry to
transmit, to a communications of a wireless communications network via a wireless access interface, one or more synchronisation signal block, SSB, burst sets, each burst set comprising one or more SSBs, the one or more SSBs in each burst set being transmitted on a respective one or more beams, wherein the wireless access interface comprises a plurality of slots, each of the plurality of slots comprising a plurality of Orthogonal Frequency Division Multiplexing, OFDM, symbols for transmitting the plurality of SSBs in each burst set, one or more of the OFDM symbols being SBFD OFDM symbols and one or more of the OFDM symbols being non-SBFD OFDM symbols, and
transmit, to the communications device, information for the communications device to determine, for each beam, how to adjust a signal quality measurement of one or more of the SSBs received on the beam according to whether the SSBs are received in the plurality of SBFD OFDM symbols or the plurality of non-SBFD OFDM symbols.

Paragraph 47. A wireless communications network comprising a communications device according to paragraph 43 and infrastructure equipment according to paragraph 44.

Paragraph 48. A computer program comprising instructions which, when program is executed by a computer, cause the computer perform the method of any of paragraphs 1 to 42.

Paragraph 49. A non-transitory computer-readable storage medium storing a computer program according to paragraph 48.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] RP-213591, “New SI: Study on evolution of NR duplex operation,” CMCC, RAN #94e, December 2021.
[4] RP-220633, “Revised SID: Study on evolution of NR duplex operation,” CMCC, RAN #95e, March 2022.
[5] European Patent No. 3545716.

1. A method of operating a communications device, the method comprising
receiving, from infrastructure equipment of a wireless communications network via a wireless access interface, one or more synchronisation signal block, SSB, burst sets, each burst set comprising one or more SSBs, the one or more SSBs in each burst set being received on a respective one or more beams, wherein the wireless access interface comprises a plurality of slots, each of the plurality of slots comprising a plurality of Orthogonal Frequency Division Multiplexing, OFDM, symbols for receiving the one or more of SSBs in each burst set, one or more of the OFDM symbols being SBFD OFDM symbols and one or more of the OFDM symbols being non-SBFD OFDM symbols,
determining a signal quality for each beam based on a signal quality measurement of one or more of the SSBs received on the beam including adjusting the measurement of the signal quality of the one or more of SSBs received on the beam according to whether they are received in the plurality of SBFD OFDM symbols or the plurality of non-SBFD OFDM symbols.

2. A method according to claim 1, wherein the adjusting the measurement of the signal quality of the one or more of the SSBs received on the beam according to whether they are received in the plurality of SBFD OFDM symbols or the plurality of non-SBFD OFDM symbols comprises selecting the SSBs received on the beam in the plurality of non-SBFD OFDM symbols for signal quality measurement and excluding the SSBs received on the beam in the plurality of SBFD OFDM symbols from signal quality measurement.

3. A method according to claim 1, wherein the adjusting the measurement of the signal quality of the one or more of the SSBs received on the beam according to whether they are received in the plurality of SBFD OFDM symbols or the plurality of non-SBFD OFDM symbols comprises
selecting the SSBs received on the beam in the plurality of SBFD OFDM symbols for signal quality measurement and excluding the SSBs received on the beam in the plurality of non-SBFD OFDM symbols from signal quality measurement.

4. A method according to claim 1, wherein the adjusting the measurement of the signal quality of the one or more of the SSBs received on the beam according to whether they are received in the plurality of SBFD OFDM symbols or the plurality of non-SBFD OFDM symbols comprises
measuring a signal quality of one or more of the SSBs received on the beam in the plurality of SBFD OFDM symbols,
measuring a signal quality of one or more of the SSBs received on the beam in the plurality of non-SBFD OFDM symbols,
determining an inter-subband cross link interference, CLI, based on a difference between the measured signal quality of the one or more SSB received on the beam in the plurality of SBFD OFDM symbols and the measured signal quality of the one or more SSBs received on the beam in the plurality of non-SBFD OFDM symbols, wherein the determining the signal quality for each beam comprises
determining the signal quality for each beam based on the determined inter-subband CLI for each beam.

5. A method according to claim 1, wherein the adjusting the signal quality measurement of the one or more SSBs received on the beam according to whether they are received in the plurality of SBFD OFDM symbols or the plurality of non-SBFD OFDM symbols comprises
changing a measured signal quality of the SSBs received in the plurality of SBFD OFDM symbols relative to a measured signal quality of the SSBs received in the plurality of non-SBFD OFDM symbols by an offset, Δ_{SBFD}.

6. A method according to claim 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
applying the offset to the measured signal quality of each of the SSBs received in the plurality of SBFD OFDM symbols.

7. A method according to claim 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining an average of the measured signal quality of each of the SSBs received in the plurality of SBFD OFDM symbols,
applying the offset to the average measured signal quality of the SSBs received in the plurality of SBFD OFDM symbols.

8. A method according to claim 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
multiplying the measured signal quality of each of the SSBs received in the plurality of SBFD OFDM symbols by the offset.

9. A method according to claim 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining an average of the measured signal quality of each of the SSBs received in the plurality of SBFD OFDM symbols,
multiplying the average measured signal quality of each of the SSBs received in the plurality of SBFD OFDM symbols by the offset.

10. A method according to claim 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining a transmit power of the SSBs received in SBFD OFDM symbols and determining the offset based on the transmit power.

11. A method according to claim 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining a number of the SSBs received in the SBFD OFDM symbols within a predefined time window,
determining a number of the SSBs received in the non-SBFD OFDM symbols within the predefined time window,
determining the offset based on a ratio of the number of the SSBs received in the SBFD OFDM symbols, X_{SBFD}, within the predefined time window and the number of the SSBs received in the non-SBFD OFDM symbols, X_{Non-SBFD}, within the predefined time window.

12. A method according to claim 11, wherein the offset is determined according to
$${Δ}_{SBFD} = α \frac{{X}_{SBFD}}{{X}_{Non - SBFD}} ,$$
where α is a number.

13. A method according to claim 11, wherein the offset is determined according to
$${Δ}_{SBFD} = {log}_{10} ( α \frac{{X}_{SBFD}}{{X}_{Non - SBFD}} ) ,$$
where α is a number.

14. A method according to claim 5, wherein the changing the measured signal quality of the SSBs received in the plurality of SBFD OFDM symbols relative to the measured signal quality of the SSBs received in the plurality of non-SBFD OFDM symbols by the offset, Δ_{SBFD}, comprises
determining a number of the SSBs received in the SBFD OFDM symbols within a predefined time window,
determining a number of the SSBs received in the non-SBFD OFDM symbols within the predefined time window,
determining the offset based on a ratio of the number of the SSBs received in the SBFD OFDM symbols, X_{SBFD}, within the predefined time window to the sum of the number of the SSBs received in the SBFD OFDM symbols, X_{SBFD}, within the predefined time window and the number of the SSBs received in the non-SBFD OFDM symbols, X_{Non-SBFD}, within the predefined time window.

15.-16. (canceled)

17. A method according to claim 12, wherein the number, a, is received in a system information block, SIB, from the infrastructure equipment or fixed in the specifications.

18. A method according to claim 5, wherein the increasing the measured signal quality of the SSBs received in the plurality of SBFD OFDM symbols relative to the measured signal quality of the SSBs received in the plurality of non-SBFD OFDM symbols by the offset, Δ_{SBFD}, comprises
measuring a signal quality of the SSBs received on the beam in the SBFD OFDM symbols,
measuring a signal quality of the SSBs received on the beam in the non-SBFD OFDM symbols,
determining an inter-subband cross link interference, CLI, I_{CLI}, based on a difference between the measured signal quality of the SSBs received on the beam in in the SBFD OFDM symbols and the measured signal quality of the SSBs received on the beam in the non-SBFD OFDM symbols, and
determining the offset based on the determined inter subband CLI.

19.-24. (canceled)

25. A method according to claim 1, wherein the adjusting the measurement of the signal quality of one or more SSBs received on the beam according to whether they are received in the plurality of SBFD OFDM symbols or the plurality of non-SBFD OFDM symbols comprises
determining that a plurality of SSBs are received on the beam,
determining that the plurality of SSBs received on the beam overlap with non-SBFD OFDM symbols to differing extents,
selecting one or more of the plurality of SSBs received on the beam for signal measurement based on the extent to which the SBFDs overlap with the non-SBFD OFDM symbols.

26. A method according to claim 1, wherein the SBFD OFDM symbols comprise an uplink region reserved for uplink communications resources and a downlink region reserved for downlink communications resources, the uplink and downlink regions being separated by a boundary.

27.-42. (canceled)

43. A communications device comprising
a transmitter configured to transmit signals,
a receiver configured to receive signals, and
a controller configured in combination with the transmitter and the receiver to
receive, from infrastructure equipment of a wireless communications network via a wireless access interface, one or more synchronisation signal block, SSB, burst sets, each burst set comprising one or more SSBs, the one or more SSBs in each burst set being received on a respective one or more beams, wherein the wireless access interface comprises a plurality of slots, each of the plurality of slots comprising a plurality of Orthogonal Frequency Division Multiplexing, OFDM, symbols for receiving the one or more of SSBs in each burst set, one or more of the OFDM symbols being SBFD OFDM symbols and one or more of the OFDM symbols being non-SBFD OFDM symbols, and
determine a signal quality for each beam based on a signal quality measurement of one or more of the SSBs received on the beam including adjusting the measurement of the signal quality of the one or more of SSBs received on the beam according to whether they are received in the plurality of SBFD OFDM symbols or the plurality of non-SBFD OFDM symbols.

44. Infrastructure equipment for a wireless communications network, the infrastructure equipment comprising
a transmitter configured to transmit signals,
a receiver configured to receive signals, and
a controller configured in combination with the transmitter and the receiver to
transmit, to a communications of a wireless communications network via a wireless access interface, one or more synchronisation signal block, SSB, burst sets, each burst set comprising one or more SSBs, the one or more SSBs in each burst set being transmitted on a respective one or more beams, wherein the wireless access interface comprises a plurality of slots, each of the plurality of slots comprising a plurality of Orthogonal Frequency Division Multiplexing, OFDM, symbols for transmitting the plurality of SSBs in each burst set, one or more of the OFDM symbols being SBFD OFDM symbols and one or more of the OFDM symbols being non-SBFD OFDM symbols, and
transmit, to the communications device, information for the communications device to determine, for each beam, how to adjust a signal quality measurement of one or more of the SSBs received on the beam according to whether the SSBs are received in the plurality of SBFD OFDM symbols or the plurality of non-SBFD OFDM symbols.

45.-49. (canceled)
